(19) United States
(12) Patent Application Publication
(10) Pub. No.: US 2010/0253875 A1
(43) Pub. Date: Oct. 7, 2010

(54) Position tuning structure and adjustable optical film device comprising the same

(75) Inventors: Cheng-Chung Hu, Taoyuan City (TW); Hung-Jen Chu, Jhongli City (TW); Long-Cai Jhuo, Banciao City (TW)

Correspondence Address: BACON & THOMAS, PLLC, 625 SLATERS LANE, FOURTH FLOOR, ALEXANDRIA, VA, 22314-1176, US

(73) Assignee: Chunghwa Picture Tubes, Ltd., Bade City (TW)

(21) Appl. No.: 12/654,466

(22) Filed: Dec. 22, 2009

(30) Foreign Application Priority Data
Apr. 7, 2009 (TW) 098205576

(51) Int. Cl. G02F 1/1333

(52) U.S. Cl. 349/60

(57) ABSTRACT

A position tuning structure is disclosed, which comprises a holding tube having a side hole extending through the wall of the holding tube; a nut locating in the holding tube and connecting to the side hole; a tuning element threadedly engaged in the nut; an elastic rod locating in the holding tube and pushed by the tuning element; a supporting element locating in the holding tube and pushed by the elastic rod; and an elastic element locating in the holding tube and connecting to the supporting element. Also, an adjustable optical film device comprising the above position tuning structure is disclosed.

### BACKGROUND OF THE INVENTION

1. Field of the Invention

The present invention relates to a position tuning structure and an adjustable optical film device comprising the same and, more particularly, to a position tuning structure of an optical device and an adjustable optical film device of a liquid crystal display device.

2. Description of Related Art

Devices with grating films such as protective filter shield devices, anti-glare devices, or three-dimensional optical devices for the liquid crystal display (LCD) devices are usually settled or hung on the LCD devices by clips or hangers. Therefore, when the angle of the positioned optical grating device is incorrect, it is difficult to correct the angle by changing the grating device to a proper position since no element designed for tuning the angle in the optical grating device is set. Though some position of the optical grating device can be changed manually, it cannot be done satisfactorily when the angle required to be changed is very small.

Therefore, an adjustable optical film device has been proposed in prior art, as shown in FIG. 1, which comprises: an optical film 15 having a jagged edge 14; a frame 11 having a plurality of holding elements (not shown) using to fix the frame 11 on the LCD device; two tracks 12 for the moving of the optical film 15; and two knobs 13 for adjusting the position of the optical film 15.

Although the position of optical film 14 of the proposed adjustable optical film device can be adjusted as expected, it is not user-friendly. For example, when a fine angle is required to be changed, it is difficult to achieve due to a large pitch of the jagged edge. As the pitch of the jagged edge has a minimum value that cannot be reduced any further, the difficulties for the tuning of fine angles increase. Besides, according to the conventional adjustable optical film device, at least one side of the optical film 15 must be made in an arc shape, therefore the area of the optical film 15 should be enlarged to ensure that the displaying area of the LCD device is completely shielded with the optical film 15.

Therefore, it is desirable to provide an improved position tuning structure for a grating device of an LCD device to overcome the aforementioned problems.

### SUMMARY OF THE INVENTION

The present invention provides a position tuning structure for an optical device (such as a protective filter shield device, an anti-glare device, or a three-dimensional optical device) of an LCD device, which comprises: a holding tube, which has a first side hole extending through a wall of the holding tube; a nut locating in the holding tube and connecting to the wall of the holding tube, wherein the nut having a through hole corresponding to the first side hole of the holding tube such that the through hole and the first side hole share a common opening; a tuning element threadedly engaged in the common opening; an elastic rod locating in the holding tube and connecting to the tuning element; a first supporting element locating in the holding tube and contacting to the elastic rod, wherein the tuning element delivers a force to push the elastic rod towards the first supporting element; and an elastic element locating in the holding tube and connecting to the first supporting element such that the first supporting element locates between the elastic rod and the elastic element.

When the position tuning structure of the present invention is applied to an optical film device, the target object connected with the first supporting element of the position tuning structure can be favored to the position as required by turning the tuning element using a tool such as a screwdriver. In detail, when the tuning element is turned, the elastic rod connected to the tuning element will move, in accordance with the movement of the first supporting element, and then the target object connected with the first supporting element will move to a desired position. Therefore, it is easy to precisely tune the positioning angle of the target object since the turning angle (or the number of turns) of the tuning element can be counted from the screw pitch of the tuning element and the expected moving distance.

According to the position tuning structure of the present invention, the tuning element is preferably a screw.

According to the position tuning structure of the present invention, the elastic element is preferably a spring.

According to the position tuning structure of the present invention, the elastic rod is preferably made of rubber.

The position tuning structure of the present invention preferably further comprises a second supporting element locating in the holding tube and connecting to the elastic element, such that the elastic element is locating between the first supporting element and the second supporting element.

According to the position tuning structure of the present invention, the holding tube preferably further comprises a second side hole extending through the wall of the holding tube, such that the first supporting element protrudes from the holding tube through the second side hole of the holding tube.

The present invention also provide an adjustable optical film device comprising: a frame having a position tuning structure connecting to a side of the frame and a plurality of holding elements set at the two opposite sides of the frame; and an optical film held by the frame. The position tuning structure comprises: a holding tube, which has a first side hole extending through a wall of the holding tube; a nut locating in the holding tube and connecting to the wall of the holding tube, wherein the nut having a through hole corresponding to the first side hole of the holding tube—such that the through hole and the first side hole share a common opening; a tuning element threadedly engaged in the common opening; an elastic rod locating in the holding tube and connecting to the tuning element; a first supporting element locating in the holding tube and connecting to the elastic rod (the tuning element delivers a force to push the elastic rod towards the first supporting element); and an elastic element locating in the holding tube and connecting to the first supporting element such that the first supporting element locates between the elastic rod and the elastic element.

The adjustable optical film device of the present invention may be a protective filter shield device, an anti-glare device, or a three-dimensional optical device of an LCD device, or any other optical devices for an LCD device.

According to the adjustable optical film device of the present invention, the position of the frame can be adjusted by turning the tuning element of the position tuning structure using a tool such as a screwdriver. Therefore, it is easy to precisely tune the positioning angle of the frame since the turning angle (or the number of turns) of the tuning element can be counted from the screw pitch of the tuning element and the expected moving distance.

According to the adjustable optical film device of the present invention, the holding tube preferably further comprises a second side hole extending through the wall of the holding tube such that the first supporting element connects with the frame through the second side hole of the holding tube.

According to the adjustable optical film device of the present invention, preferably at least one of the plurality of holding elements connects with the position tuning structure.

According to the adjustable optical film device of the present invention, the tuning element is a screw.

According to the adjustable optical film device of the present invention, the elastic element is a spring.

According to the adjustable optical film device of the present invention, the elastic rod is made of rubber.

The adjustable optical film device of the present invention preferably further comprises a second supporting element locating in the holding tube and connecting to the elastic element, such that the elastic element locates between the first supporting element and the second supporting element.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a conventional adjustable optical film device;

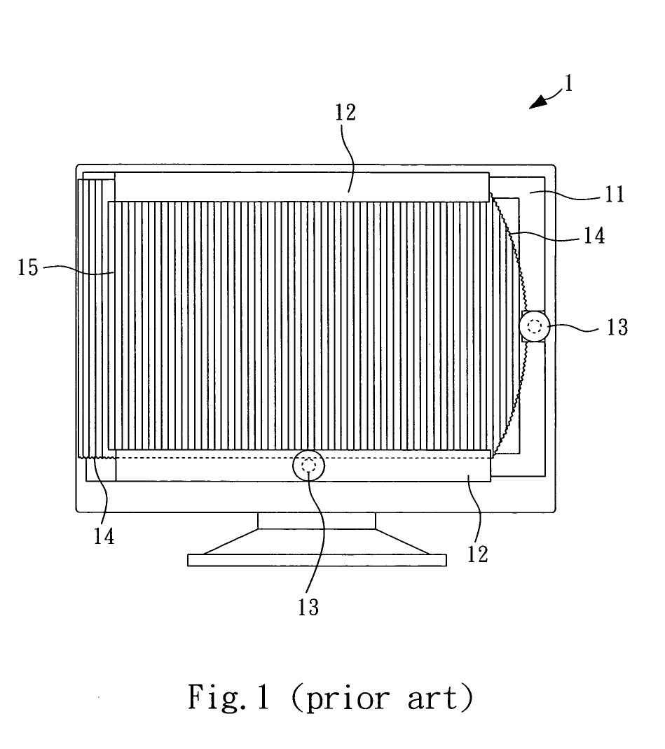

FIG. 2 is a schematic drawing of a position tuning structure for a optical device of an LCD device of the present invention; and

FIG. 3 is a schematic drawing of an adjustable optical film device of the present invention.

### DETAILED DESCRIPTION OF THE PREFERRED EMBODIMENT

### Example 1

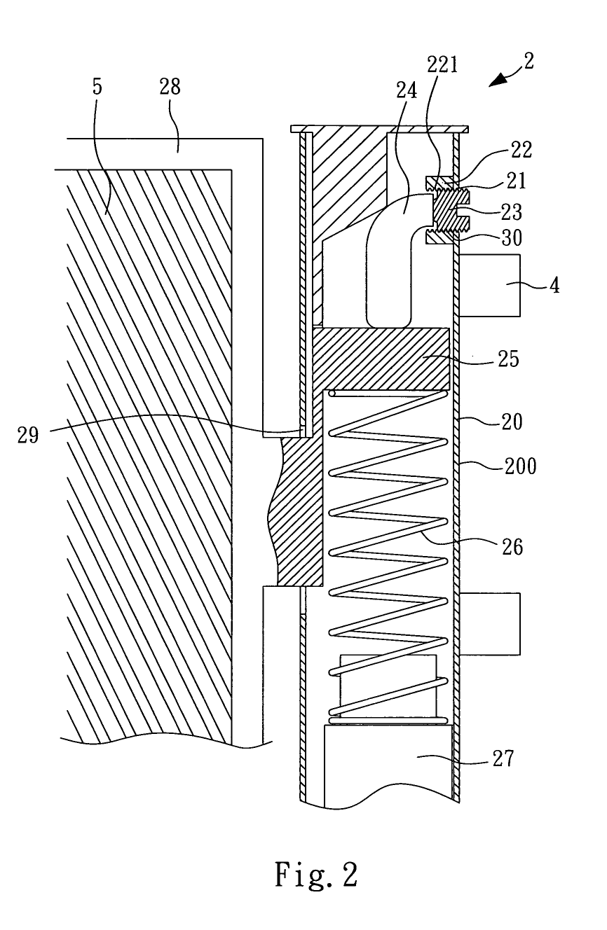

In reference with FIG. 2, the position tuning structure 2 of the example comprises: a holding tube 20, a nut 22, a tuning element 23, an elastic rod 24, a first supporting element 25, an elastic element 26, and second supporting element 27. The holding tube 20 has a first side hole 21 and a second side hole 29 extending through a wall 200 of the holding tube 20. The nut 22 locates in the holding tube 20 and connects to the wall 200 of the holding tube 20, wherein the nut 22 having a through hole 221 corresponding to the first side hole 21 of the holding tube 20 such that the through hole 221 and the first side hole 21 share a common opening 30. The tuning element 23 is threadedly engaged in the common opening 30. The elastic rod 24 locates in the holding tube 20 and connects to the tuning element 23. Part of the first supporting element 25 locates in the holding tube 20 and contacts with the elastic rod 24 such that the tuning element 23 delivers a force to push the elastic rod 24 towards the first supporting element 25. Part of the first supporting element 25 protrudes from the holding tube 20 through the second side hole 29 of the holding tube 20, and the extruded first supporting element 25 connects with a target object 28. The elastic element 26 locates in the holding tube 20 and connects to the first supporting element 25 such that the first supporting element 25 locates between the elastic rod 24 and the elastic element 26. The second supporting element 27 locates in the holding tube 20 and connects to the elastic element 26 such that the elastic element 26 locates between the first supporting element 25 and the second supporting element 27.

In the present example, the tuning element 23 is a screw, the elastic element 26 is a spring, and the elastic rod 24 is made of rubber. Target object 28 comprises an optical film 5. Holding elements 4 are connected with the position tuning structure 2.

When the position tuning structure 2 of the present invention is applied to optical film devices such as protective filter shield devices, anti-glare devices, or three-dimensional optical devices, the target object 28 connected with the first supporting element 25 of the position tuning structure 2 can be favored to the position as expected by turning the tuning element 23 using a tool such as a screwdriver. In detail, when the tuning element 23 is turned, the elastic rod 24 connected to the tuning element 23 will move, in accordance with the movement of the first supporting element 25, and then the target object 28 connected with the first supporting element 25 will move to a desired position. Therefore, it is easy to precisely tune the positioning angle of the target object 28 since the turning angle (or the number of turns) of the tuning element 23 can be counted from the screw pitch of the tuning element 23 and the expected moving distance. For example, when the screw pitch of the tuning element 23 is 10 μm, a half cycle turn (i.e. 180°) of the tuning element 23 can obtain a moving distance of 5 μm.

### Example 2

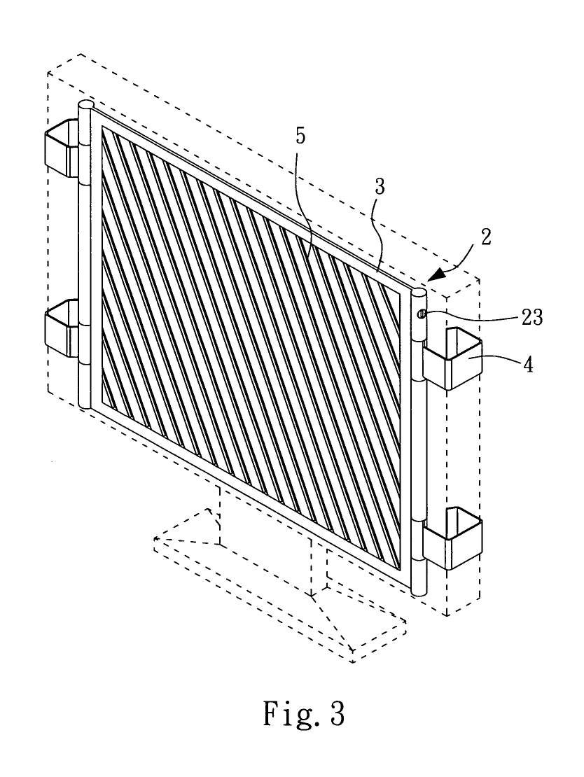

In reference with FIGS. 2 and 3, a schematic drawing of an adjustable optical film device of the present invention is shown. The adjustable optical film device of the present example comprises: a frame 3 having a position tuning structure 2 connecting to a side of the frame 3 and a plurality of holding elements 4 set at the two opposite sides of the frame 3; and an optical film 5 held by the frame 3. In the present example, the position tuning structure 2 is the same as that described in the example 1.

In the present example, the adjustable optical film device can be settled on an LCD device with the holding elements 4. Subsequently, the position of the frame 3 can be adjusted by turning the tuning element 23 of the position tuning structure 2 using a tool such as a screwdriver. Therefore, it is easy to precisely tune the positioning angle of the frame 3 since the turning angle (or the number of turns) of the tuning element 23 can be counted from the screw pitch of the tuning element 23 and the expected moving distance. For example, when the screw pitch of the tuning element 23 is 10 μm, a half cycle turn (i.e. 180°) of the tuning element 23 can obtain a moving distance of 5 μm.

The adjustable optical film device of the present invention enables the position tuning of the optical film for fine angles to be achieved with a simple tool, therefore it is a practical novel invention that cannot be realized in the prior arts.

Although the present invention has been explained in relation to its preferred embodiment, it is to be understood that many other possible modifications and variations can be made without departing from the scope of the invention as hereinafter claimed.

What is claimed is:

1. A position tuning structure, which comprises:
a holding tube having a first side hole extending through a wall of the holding tube;
a nut locating in the holding tube and connecting to the wall of the holding tube, wherein the nut having a through hole corresponding to the first side hole of the holding tube such that the through hole and the first side hole share a common opening;
a tuning element threadedly engaged in the common opening;
an elastic rod locating in the holding tube and connecting to the tuning element;
a first supporting element locating in the holding tube and contacting to the elastic rod; and
an elastic element locating in the holding tube and connecting to the first supporting element such that the first supporting element locates between the elastic rod and the elastic element.

2. The position tuning structure as claimed in claim 1, wherein the tuning element is a screw.

3. The position tuning structure as claimed in claim 1, wherein the elastic element is a spring.

4. The position tuning structure as claimed in claim 1, wherein the elastic rod is made of rubber.

5. The position tuning structure as claimed in claim 1, further comprising a second supporting element locating in the holding tube and connecting to the elastic element, such that the elastic element is locating between the first supporting element and the second supporting element.

6. The position tuning structure as claimed in claim 1, wherein the holding tube further comprises a second side hole extending through the wall of the holding tube, such that the first supporting element protrudes from the holding tube through the second side hole of the holding tube.

7. An adjustable optical film device comprising:
a frame having a position tuning structure connecting to a side of the frame and a plurality of holding elements setting at the two opposite sides of the frame; and
an optical film held by the frame;
wherein the position tuning structure comprises: a holding tube, which has a first side hole extending through a wall of the holding tube; a nut locating in the holding tube and connecting to the wall of the holding tube, wherein the nut having a through hole corresponding to the first side hole of the holding tube such that the through hole and the first side hole share a common opening; a tuning element threadedly engaged in the common opening; an elastic rod locating in the holding tube and connecting to the tuning element; a first supporting element locating in the holding tube and contacting to the elastic rod; and an elastic element locating in the holding tube and connecting to the first supporting element such that the first supporting element locates between the elastic rod and the elastic element.

8. The adjustable optical film device as claimed in claim 7, wherein the holding tube further comprises a second side hole extending through the wall of the holding tube, and the first supporting element connects with the frame through the second side hole of the holding tube.

9. The adjustable optical film device as claimed in claim 7, wherein at least one of the plurality of holding elements connects with the position tuning structure.

10. The adjustable optical film device as claimed in claim 7, wherein the tuning element is a screw.

11. The adjustable optical film device as claimed in claim 7, wherein the elastic element is a spring.

12. The adjustable optical film device as claimed in claim 7, wherein the elastic rod is made of rubber.

13. The adjustable optical film device as claimed in claim 7, further comprising a second supporting element locating in the holding tube and connecting to the elastic element, such that the elastic element locates between the first supporting element and the second supporting element.
